(19) United States
(12) Patent Application Publication
(10) Pub. No.: US 2007/0286704 A1
(43) Pub. Date: Dec. 13, 2007

(54) Picture stabilizers

(76) Inventor: Steven Lynn Signor, Denton, TX (US)

Correspondence Address: STEVEN L. SIGNOR, 6812 HAYLING WAY, DENTON, TX, 76210, US

(21) Appl. No.: 11/724,127

(22) Filed: Mar. 14, 2007

Related U.S. Application Data
(60) Provisional application No. 60/792,861, filed on Apr. 18, 2006.

(51) Int. Cl. F16B 15/00

(52) U.S. Cl. 411/458

(57) ABSTRACT

Picture Stabilizers are a special class of devices that provide an easy and effective means to stabilize pictures, paintings, mirrors, plaques, signs and other objects. Picture Stabilizers help to maintain the aesthetic positioning of these objects so that they do not need to be straightened or reoriented due to misalignment caused by disturbances such as vibrations from vehicles, jets, trains, loud music, slamming doors, minor earthquakes, being bumped, jarred, touched, or due to being otherwise disturbed and brought out of alignment from the way such objects were originally intended to be displayed.

### CROSS-REFERENCE TO RELATED APPLICATIONS

This application claims the benefit of provisional patent application Ser. No. 60/792,861, filed on 2006 Apr. 18 by the present inventor.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

This invention pertains to a special class of hardware fasteners herein referred to as Picture Stabilizers, or singularly, Picture Stabilizer. This invention includes four types of Picture Stabilizers, along with optional special application tools or accessories to facilitate the installation process.

Pictures, paintings, mirrors, plaques, signs, and other objects that have been structurally fastened onto walls or other surfaces often have the tendency to move out of position when being bumped, jarred, or when disturbed by loud noises or vibrations such as from passing vehicles, trains, jets, loud music, minor earthquakes, or by other disturbances, and therefore such objects need to be straightened or repositioned occasionally.

Picture Stabilizers provide a means for keeping such objects stabilized so that they will not need to be occasionally straightened or reoriented due to misalignment caused by vibrations or other disturbances; By using Picture Stabilizers, it is assumed that said objects are already, or will be, structurally anchored by other appropriate and effective means; So the purpose and intended function of Picture Stabilizers is not to keep such objects structurally anchored in order to keep them from falling due to inadequate support, but rather to keep such objects aesthetically stabilized so as not to become misaligned after being mounted. Prior art US patents show various means to initially mount such objects, but do not appear to show independent means to keep such objects aesthetically stabilized afterward.

Relative to this invention is prior art U.S. Pat. No. 1,272,696 to Mock (1918) that teaches the use of a double-pointed pin used as a single device for the primary structural support of articles such as pictures on walls. The Mock invention utilizes a removable head that fits over one end of the double-pointed pin that, after said removable head has been used as a means to guide and transfer the loads from a striking hammer onto the pin in order to drive a portion of the pin into a wall without damaging the pin, said removable head is afterward removed. The picture or article is then pressed onto the remaining portion of the protruding pin, or else a special hanger that resembles a wooden hook is attached to the protruding pin, and the picture or article is then hung from the special hanger. The Mock invention, however, was designed for a primary anchoring or fastening purpose. It did not have an integral head like the Picture Stabilizer Pin, nor did the Mock invention address or recognize the problem of pictures or objects becoming misaligned due to vibrations or other disturbances.

Also related to this invention is prior art U.S. Pat. No. 5,123,584 to Harrison (1992), that shows a multi-pointed nail driver system that includes the use of special two-pointed nails as part of a system “provided for joining materials, such as planks together.” This multi-pointed nail driver system by Harrison was designed for the nail class of fasteners and was intended to be used “in the woodworking and construction industries, in carpeting or just for handymen” to join “two pieces of material, such as wood,” or “materials, such as planks together.” The driver for the Harrison multi-pointed nail driver system was to be struck with a hammer in order to drive the two-pointed nail into the intended material. The second material was then driven onto the fastener.

Picture Stabilizers are very different from the Harrison invention because Picture Stabilizers are not used for a primary structural purpose, but rather, as a subordinate fastener for aesthetic purposes, transferring very insignificant lateral loads that are not even associated with the primary structural function of holding the picture or object on the wall so as not to fall down.

Picture Stabilizers are also different from the Harrison invention because they are to be pressed into the material, like standard push-type pins, or screwed or stuck, rather than to be struck or hammered into the material as the Harrison invention requires.

In addition, U.S. Pat. No. 6,042,078 by Donovan (2000) introduced a wall-mounting hanger that does not utilize a double-pointed pin, but the Donovan patent does teach the use of pins as fasteners, but again, the Donovan wall-mounting hanger was for a primary anchoring purpose, and not for a subordinate, aesthetic purpose as the Picture Stabilizers serve.

### BRIEF SUMMARY OF THE INVENTION

People generally focus their attention on structurally hanging or mounting pictures or objects to begin with, and then focus on straightening or orienting those objects afterwards. People commonly do not think about maintaining the aesthetic orientation of the pictures or objects while they are in the process of hanging or mounting them, and it is generally assumed that such objects will probably need to be straightened, reoriented or realigned from time to time should they be bumped or otherwise disturbed.

The need for these types of pictures or objects to be straightened or realigned has been an ongoing problem that the general public has been aware of for centuries, but this problem has not been resolved by inventions specifically designed to mitigate this problem. There have been many inventions designed as primary structural anchors, fasteners or systems, but none have been specifically designed or marketed to serve as subordinate, aesthetic fasteners for the express purpose of stabilizing pictures or objects that are subject to the problem of misalignment caused by vibrations or other disturbances.

Also, pictures or other objects that have become misaligned due to vibrations or other disturbances tend to be a visual distraction or an annoyance to many people. Some people, often perfectionists, find it so disturbing that they can be seen straightening pictures wherever they go. An example of this being a common problem can be observed in the 1964 Academy Award winning film entitled, “Father Goose,” starring Cary Grant and Leslie Caron, where Leslie Caron tries to straighten Cary Grant's picture three times while on his boat.

Additionally, some people perceive crooked pictures and paintings in a home to be a sign of untidiness. Items being randomly scattered about a room, and pictures on the walls that appear crooked or misaligned are considered by many to be examples of an unkempt or untidy condition. Therefore, because Picture Stabilizers may be retrofitted onto pictures and other objects that are already hanging, the installation of Picture Stabilizers provides an easy means to correct the problems of crookedness and misalignment, and it also reduces the maintenance required around the home or office in order to maintain a tidy and organized appearance. Picture Stabilizers may also keep pictures or objects fastened to the primary structural anchor in the event of an earthquake.

### BRIEF DESCRIPTION OF THE SEVERAL VIEWS OF THE DRAWING

FIGS. 1-4 are perspective representations of the Type 1 Picture Stabilizers.

FIGS. 5 and 6 are perspective representations of the Type 2 and Type 3 Picture Stabilizers, respectivelv.

FIG. 7 is a perspective view representation of an Optional Picture Stabilizer Pin Attachment Device.

FIG. 8 is another perspective view representation of an Optional Picture Stabilizer Pin Attachment Device.

FIG. 9 is a perspective view representation of an optional Special Hex Bit Accessory Tool for MultiBit Screwdrivers and Electric Drill Drivers, for use with the Pin-Screw Combo Picture Stabilizers.

FIG. 10 is a representation of the backside view of a typical picture frame retrofitted with Picture Stabilizers.

FIG. 11a is a side view representation of a typical picture frame having already been hung on a wall, shown with the lower part of the picture frame extended out from the wall in the retrofit position. and having already been retrofitted with Picture Stabilizers.

FIG. 11b is a side view representation showing a picture frame already retrofitted with Picture Stabilizers in the stabilized position.

### DETAILED DESCRIPTION OF THE INVENTION

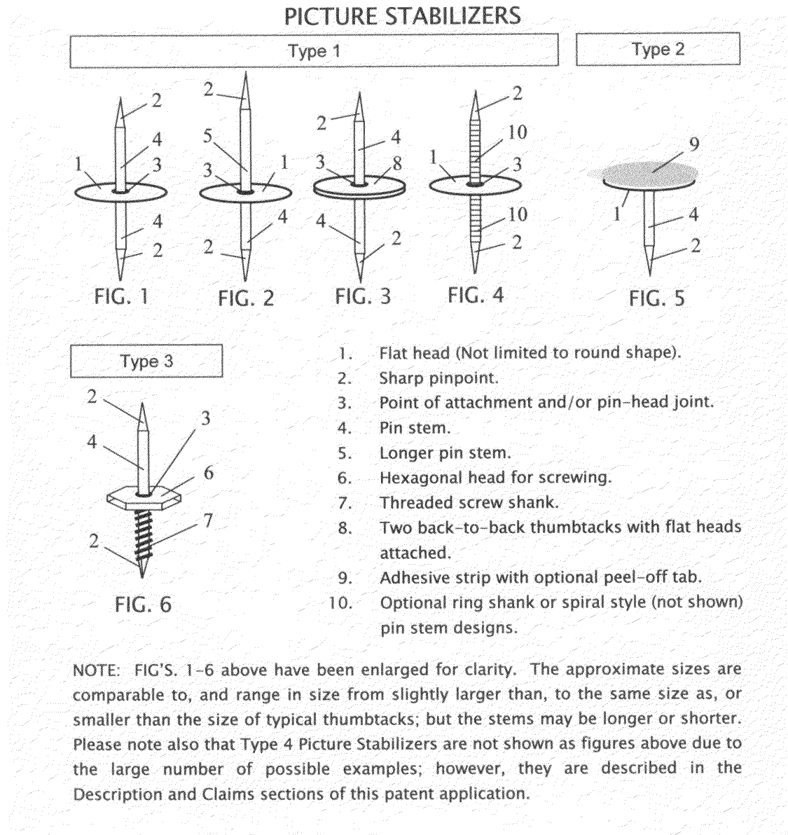

FIGS. 1-6 have been enlarged for clarity. The approximate sizes are comparable to, and range in size from slightly larger than, to the same size as, or slightly smaller than the size of typical thumbtacks: but the stems may be longer or shorter.

FIG. 1 is a perspective view of a Type 1 Picture Stabilizer, showing the flat head 1 not limited to round shape. the sharp pinpoint 2, the point of attachment and/or the pinhead joint 3, and the pin stem 4. This figure being further described in this section of the specification after the heading. “Four Types of Picture Stabilizers.”

FIG. 2 is a perspective view of a Type 1 Picture Stabilizer, showing the flat head 1 not limited to round shape, the sharp pinpoint 2, the point of attachment and/or the pinhead joint 3, the pin stem 4, and the longer pin stem 5. This figure being further described in this section of the specification after the heading. “Four Types of Picture Stabilizers.”

FIG. 3 is a perspective view of a Type 1 Picture Stabilizer, showing the sharp pinpoint 2, the point of attachment and/or the pinhead joint 3, the pin stem 4, and the two back-to-back thumbtacks with flat heads attached 8. This figure being further described in this section of the specification after the heading. “Four Types of Picture Stabilizers.”

FIG. 4 is a perspective view of a Type 1 Picture Stabilizer, showing the flat head 1 not limited to round shape, the sharp pinpoint 2, the point of attachment and/or the pinhead joint 3, and the optional ring shank (or spiral style, not shown) pin stem 10. This figure being further described in this section of the specification after the heading. “Four Types of Picture Stabilizers.”

FIG. 5 is a perspective view of a Type 2 Picture Stabilizer, showing the flat head 1 not limited to round shape, the sharp pinpoint 2, the pin stem 4, and the adhesive strip with optional peel-off tab 9. This figure being further described in this section of the specification after the heading. “Four Types of Picture Stabilizers.”

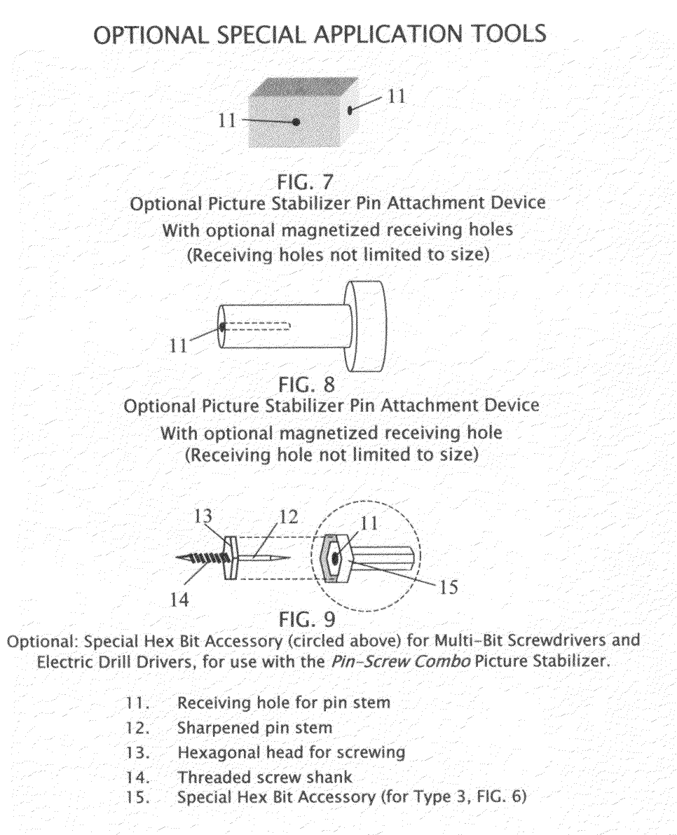

FIG. 6 is a perspective view of a Type 3 Picture Stabilizer, showing the sharp pinpoint 2, the point of attachment and/or the pinhead joint 3, the pin stem 4, the hexagonal head for screwing 6, and the threaded screw shank 7. This figure being further described in this section of the specification after the heading. “Four Types of Picture Stabilizers.”

FIG. 7 is a perspective view of an optional Picture Stabilizer Pin Attachment Device with optional magnetized receiving holes 11.

FIG. 8 is a perspective view of another optional Picture Stabilizer Pin Attachment Device with optional magnetized receiving hole 11.

FIG. 9 is a perspective view of an optional Special Hex Bit Accessory for Multi-Bit Screwdrivers and Electric Drill Drivers shown in an oriented position to receive a Type 3 Pin-Screw Combo Picture Stabilizer. This figure shows the sharpened pin stem 12, the hexagonal head for screwing 13, the threaded screw shank 14, and the dotted circled area clarifies the Special Hex Bit Accessory 15, and shows the receiving hole for the pin stem 11.

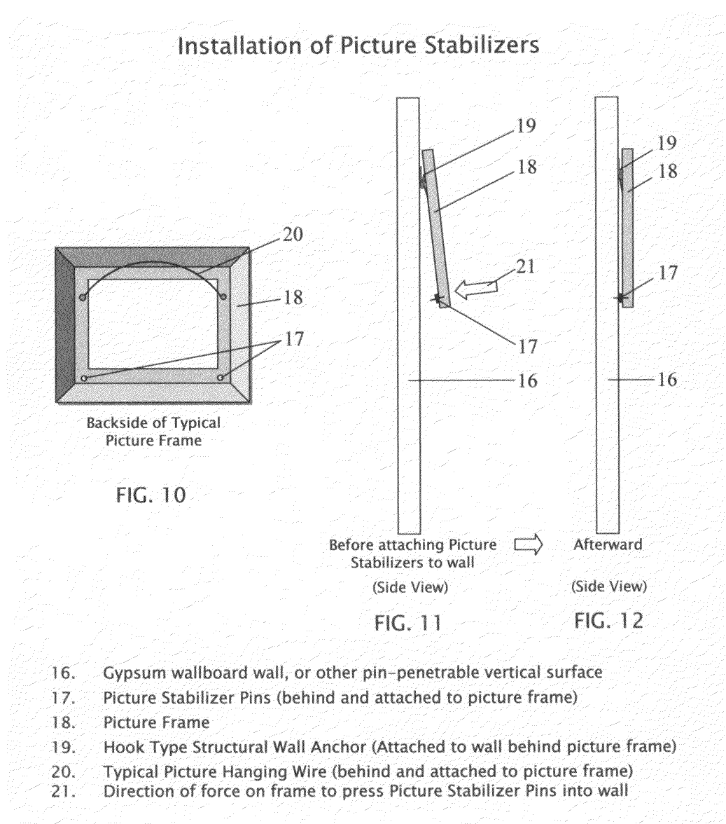

FIG. 10 is a representation of the backside view of a typical picture frame retrofitted with Picture Stabilizers 17, indicating the approximate location for the Picture Stabilizers to be attached, and showing a typical picture hanging wire 20 attached to a typical picture frame 18.

FIG. 11a shows the Picture Stabilizers 17 already having been retrofitted onto the backside of a typical picture frame 18 after first pulling the lower part of the picture frame away from the gypsum wallboard wall or other pin-penetrable vertical surface 16 in order to install the Picture Stabilizers. The figure illustrates a typical hook and wire picture frame installation 19, and the arrow 21 represents the approximate direction of force necessary to be applied to the picture frame 18 in order to engage the Picture Stabilizers, thereby stabilizing the picture frame to the wall. This figure is the first of a two-part installation sequence that includes FIGS. 11a and 11b. FIG. 11a indicates the approximate placement location for the Picture Stabilizers 17, and it shows the “retrofit position” prior to the picture frame actually being stabilized to the wall.

FIG. 11b is a side view representation showing a typical picture frame 18 that had previously been mounted to a gypsum wallboard wall or other pin-penetrable vertical surface 16, and said frame 18 has already been retrofitted with Picture Stabilizers 17, and said frame 18 in this figure is shown in the “stabilized position.”

Type 4 Picture Stabilizers are not represented as figures, but are described in the Description and claims sections of this patent specification, and also are further described in this part of the specification after the heading. “Four Types of Picture Stabilizers.”

Four Types of Picture Stabilizers:

Type 1—The “Picture Stabilizer Pin” is a double-pointed tack made of metal or other hard material suitable for the purpose of penetrating soft or wooden types of walls, surfaces or objects, and consisting of two straight pins of the same length [FIG. 1] or different lengths [FIG. 2], being attached to opposite sides of a single head like a thumbtack, but generally flat; Said head being of variable thickness and diameter; Said pins being aligned within the same ray, extending from said head and pointing in opposite directions perpendicular to the face of the head; Said pin stems having a smooth or rough surface texture [FIGS. 1-4], and being attached at or near the center of each face of the head by adhesive, brazing, soldering, or any other effective means of attachment, or said pins and head together being manufactured by being molded, cast or otherwise composed as one solid device, or manufactured instead by attaching two flathead thumbtacks back to back so that the pins point in opposite directions [FIG. 3], and said flatheads are joined or attached by being brazed, bonded with an adhesive, or by any other effective means of attachment; said thumbtacks being of suitable strength for the purpose herein described.

Type 2—The “Pin-Adhesive Strip Combo” Picture Stabilizer is a device designed with a pin and adhesive strip method of attachment [FIG. 5]; said Pin-Adhesive Strip Combo being described the same as the Type 1 Picture Stabilizer, but instead of having a pointed pin on each side of the head, said “Pin-Adhesive Strip Combo” has a pin stem on one side, and an adhesive strip fixed on the other side of the head so that the adhesive strip side may be mounted onto an object that is made of a material such as metal, hard plastic, or other material that may not be easily penetrated by a pin or a wood screw.

Type 3—The “Pin-Screw Combo” Picture Stabilizer is a double pointed device designed with a pin and screw method of attachment; Said Pin-Screw Combo [FIG. 6] being described the same as the Type 1 Picture Stabilizer, but instead of having pointed pin stems on opposite sides of the head, said “Pin-Screw Combo” has a sharp pin stem on one side, and a threaded stem, similar to a wood screw, with a sharpened point on the other side, with the head being thickened and shaped like a hexagon so that an optional Special Hex Bit Attachment [FIG. 9], designed to fit standard hand-driven multi-bit screwdrivers, or electric drills, may be used to screw the screw side into a screw-penetrable material; or said head having any other suitably shaped design that would enable the side with the screw to be screwed into a screw-penetrable surface or object by use of an optional special tool designed to fit any alternate, suitably shaped design.

Type 4—The “Type 4” Picture Stabilizer is any double-sided adhesive or fastening product promoted or marketed for use as a means for stabilizing pictures, paintings, mirrors, plaques, or other objects that, without the use of said stabilizer, such objects would otherwise be subject to misalignment due to vibrations or other disturbances. Type 4 Picture Stabilizers include any attaching products that use an adhesive, glue, or any other chemically derived means, or any mechanical means, electrical means, hook & Loop means, magnetic means or any other means of attachment, regardless of whether said means is of a temporary or permanent nature, when said means is intended for the purpose of stabilizing said objects as described herein.

The method of operation of said Picture Stabilizers is as follows:

Types 1, 2 and 4 Picture Stabilizers: The “Picture Stabilizer Pin” [FIGS. 1-4], the Picture Stabilizer “Pin-Adhesive Strip Combo” [FIG. 5], and any “Type 4” Picture Stabilizer may be attached either before or after the picture frame or object has been structurally mounted.

To attach a Type 1 “Picture Stabilizer Pin” to the frame or object while it is hanging, it is recommended that the “Picture Stabilizer Pin Attachment Device” (“Attachment Device”) be used [FIGS. 7 and 8]. This will facilitate a quick and easy attachment. Two Picture Stabilizer Pins are recommended for a stable mounting [FIG. 10, item 17]; however, one pin located directly below the structural anchor is sufficient to keep the picture stabilized for aesthetic orientation purposes.

Picture Stabilizer Pin attachment is accomplished as follows: (1) After placing the pin stem into the receiving hole of the Attachment Device, pull the lower part of the picture frame away from the wall and hold the pin-loaded Attachment Device such that it is sandwiched between the backside of the picture frame and the wall, so that the protruding pin points toward the backside of the frame; (2) Position the pin properly by placing each pin such that when both pins have been attached, one pin is located at the lower left and the other is located at the lower right backsides of the picture frame or object, at points where the backside of the picture frame or object naturally rests against the wall when hung [FIGS. 10, 11 and 12]; (3) Next, Press the picture frame or object toward the wall so that the pins are forced into the backside of the picture frame or object. Once the Picture Stabilizer Pins have been attached to the picture frame or object, simply adjust the picture frame or object to the desired aesthetic position, and then press it, forcing the Picture Stabilizer Pins into the wall. The task is complete.

The Type 2, “Pin-Adhesive Strip Combo” [FIG. 5] Picture Stabilizer is especially useful whenever the picture frame or object to be hung is made of a hard material, such as metal, that is too hard to be penetrated by a pin.

The Type 2, “Pin-Adhesive Strip Combo” Picture Stabilizer may be attached to a picture or object that is already hanging as follows: (1) Remove the adhesive strip tab to expose the adhesive strip; (2) Pull the lower part of the picture frame or object away from the wall, and stick the adhesive strip to the backside of the picture frame or object such that, if only one Picture Stabilizer is being used, it is placed directly below the wall anchor at the lower part of the picture frame or object where it naturally rests against the wall, or such that if two “Pin-Adhesive Strip Combo” Picture Stabilizers are being used, they are placed where one is located at the lower left and the other is located at the lower right backsides of the picture frame or object, at the point where the frame or object naturally rests against the wall [FIGS. 10, 11a and 11b]; (3) Then, after aesthetically orienting the picture or object, press it into the wall.

Type 3, “Pin-Screw Combo” Picture Stabilizer [FIG. 6]: The picture frame or object should be placed face down on a carpeted floor or soft work surface first before attaching the “Pin-Screw Combo” Picture Stabilizer. To attach a “Pin-Screw Combo” Picture Stabilizer to the picture frame or object, use the recommended “Special Hex Bit Accessory for Multi-Bit Screwdrivers” [FIG. 9] to screw the Picture Stabilizer into the backside of the picture frame or object. Simply place the Special Hex Bit Accessory into any standard hex type hand-held multi-bit screwdriver or electric drill driver. If the frame or object is of hardwood such as oak or walnut, you may want to pre-drill a small starter hole for the screw in order to avoid splitting or otherwise damaging the frame or object.

Attach “Pin-Screw Combo” Picture Stabilizers so that one is located at the lower left and the other is located at the lower right backsides of the picture frame or object at the point where the frame or object naturally rests against the wall [FIGS. 10, 11a, and 1b]. After the Picture Stabilizers have been attached, place the picture or object back onto the structural support anchor, orient it as desired, and then, press the picture frame or object towards the wall so that the protruding pins are pressed into the wall, thereby stabilizing the picture frame or object.

What is claimed is:

1. A special class of devices promoted or marketed as a means whereby objects such as pictures, mirrors, paintings, plaques, signs or other objects may be stabilized such that the aesthetic placement or intended display of said objects is maintained, thereby avoiding the need for such objects to be straightened, restored, or repositioned due to displacement or misalignment caused by disturbances such as vibrations from vehicles, jets, trains, loud music, slammed doors, minor earthquakes, being bumped, jarred, touched, or due to being otherwise disturbed; and the promoting or marketing of said devices may or may not include optional special tools or accessories to aid in the attachment of said devices.
